(19) United States
(12) Patent Application Publication
(10) Pub. No.: US 2008/0205731 A1
(43) Pub. Date: Aug. 28, 2008

(54) Noise Model Selection for Emission Tomography

(75) Inventors: Marc Busch, Aachen (DE); Ralph Brinks, Hagen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/914,794

(22) PCT Filed: Jun. 12, 2006
(86) PCT No.: PCT/IB2006/051869

§ 371 Date: Nov. 19, 2007

Related U.S. Application Data
(60) Provisional application No. 60/690,800, filed on Jun. 15, 2005.

(51) Int. Cl. G06K 9/00

(52) U.S. Cl. 382/131; 382/275

(57) ABSTRACT

Accurate error estimates are beneficial for many applications of emission tomography, e.g. kinetic modelling or SUV quantification with confidence levels. Due to the variety of parameters influencing the noise properties of PET images, the use of a single error model for all imaging situations and data processing set-ups leads to inaccurate error estimates. The present invention circumvents this problem by providing a database that includes a plurality of pre-determined noise models for different imaging situations. The most appropriate noise model can then be selected manually or automatically depending on the given imaging situation. Hence, the time-consuming procedure of extracting correct noise models, e.g. by utilizing a bootstrap method or by analysing repeated measurements, needs to be performed only once for each model and can be done by the vendor of the acquisition system, so that the clinician can instantly access the optimized error models from the database.

The present invention relates to a system, apparatus and method for providing noise models for emission tomography imaging situations and data process set-ups.

In emission tomography acquired data is based on radioactive nuclear decay, which is a random process. The nature and statistical properties of this process are well understood. However, this cannot be said about the statistical properties of the images that are reconstructed from the acquired data. Every part of the image processing pipeline, starting from the detector itself over the acquisition electronics and to the data interpolation, correction and reconstruction methods, influences the noise characteristics of the resulting images. Therefore, it is impossible to define a simple noise model that is appropriate for all imaging situations and all data processing set-ups.

Clinicians and researchers must individually and independently develop noise models for each set-up. In many situations it would be beneficial to have a reliable pre-defined noise model available to assist in determining accurate error estimates. For example, in kinetic modeling of dynamic data, error estimates are used as weights for the fitting procedure. Better error estimates would result in better fits. Also, in static imaging, error estimates could be used to provide the clinician with confidence levels for biological parameters, e.g. for SUV quantification in oncology applications.

Due to the variety of parameters influencing the noise properties of PET images, it is not feasible to use only one error model for all imaging situations and data processing set-ups. The analytical approaches to error estimation that can be found in the literature are problem-specific and therefore only applicable to a small subset of all imaging configurations, see, e.g., H. H. Barrett, et al., Noise Properties of the EM Algorithm: I. Theory, Phys. Med. Bio., 39, pp. 833-46, 1994, the entire contents of which is hereby incorporated by reference. The bootstrap method, see, e.g., I. Buvat, A Non-Parametric Bootstrap Approach for Analyzing the Statistical Properties of SPECT and PET Images, Phys. Med. Bio., 47, pp. 1761-75, 2002, the entire contents of which is hereby incorporated by reference, is another method for the estimation of noise properties. Compared to analytical approaches, the bootstrap method has the advantage that data replicates can be generated and statistically analysed for almost every imaging set-up. The entire image acquisition and processing chain is treated as a black box, and no detailed information about any of its elements is needed as input for the bootstrap analysis. However, this method has the disadvantage of being extremely time-consuming, which prohibits its use in most clinical situations by individual clinicians and researchers.

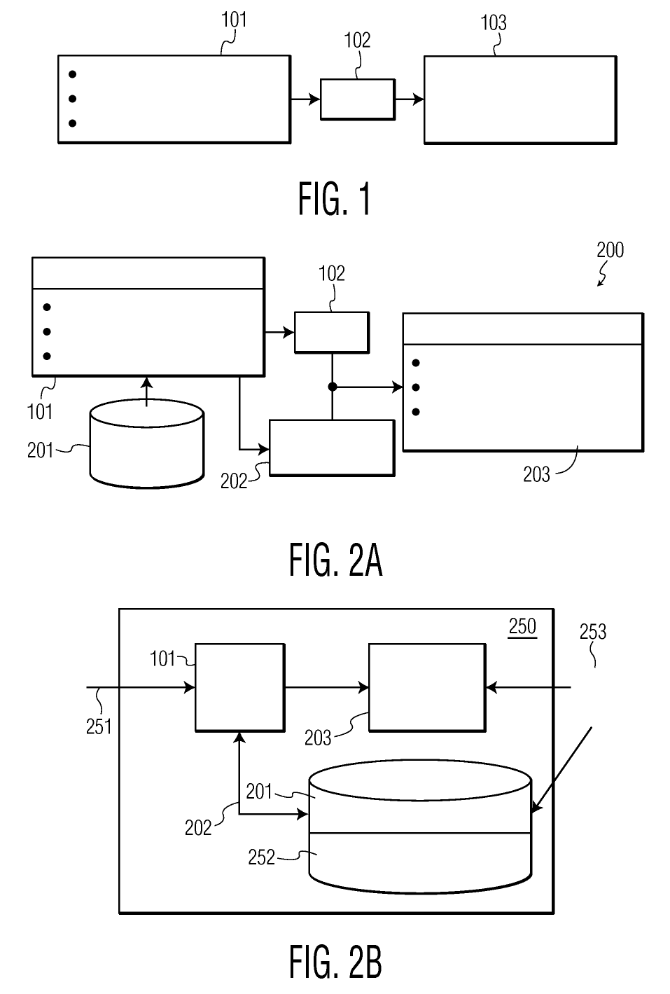

Referring now to FIG. 1, a typical procedure for error analysis is illustrated in which at step 101 data is acquired, corrected and reconstructed as an image at step 102. A simplified noise model (if any at all) is then used at step 103 for further image analysis.

Overall, there is presently no noise model available that is flexible enough to cover all situations of clinical and research interest. The models which are used in today's standard image analysis software, in most cases do not reflect the correct noise characteristics.

The system, apparatus and method of the present invention provide an effective and efficient way to provide reusable and pre-determined noise models for commonly used and pre-definable setups, thereby eliminating the need for clinicians and researchers to perform noise model determination independently and individually for these setups.

The system, apparatus, and method of the present invention provide a clinician/researcher with a tool that automatically chooses a noise model from a database of such models and which is appropriate for the specific imaging situation. In a preferred embodiment, the database is populated with noise models (indexed according to the imaging situations and setups to which they correspond) that have been extracted previously using bootstrap analyses of PET images for a number of different but typical imaging situations and set-ups. Thereby, the two main disadvantages of the above-mentioned approaches can be overcome:
1. Analytic noise models are fast but not flexible enough to cover all relevant imaging situations, e.g. the use of different reconstruction methods, scatter correction methods, etc.
2. Statistical bootstrap analyses (or similar methods, such as repeated measurements) are used to determine noise properties for every imaging situation and are therefore very flexible, but, this approach is extremely time consuming.

Providing the clinician/researcher with a database of pre-determined noise models for standard imaging situations and a tool to easily choose (or automatically select) the appropriate model for a specific application based on the application's characteristics, is a fast and flexible solution to the problem of reliable error/noise estimation. FIG. 2A illustrates a preferred embodiment of the present invention. After data acquisition, correction and image reconstruction at step 101, an appropriate noise model 202 is selected from a database 201 based on the set-up and parameters of acquisition, data correction and reconstruction. The application-specific noise model 202 allows improved noise estimation which results in better images and provides valuable information to the clinician/researcher.

FIG. 1 illustrates a typical process for the acquisition and imaging procedure;

FIG. 2A illustrates the process of FIG. 1 modified according to the present invention;

FIG. 2B illustrates an image analysis apparatus that implements the process of FIG. 2A;

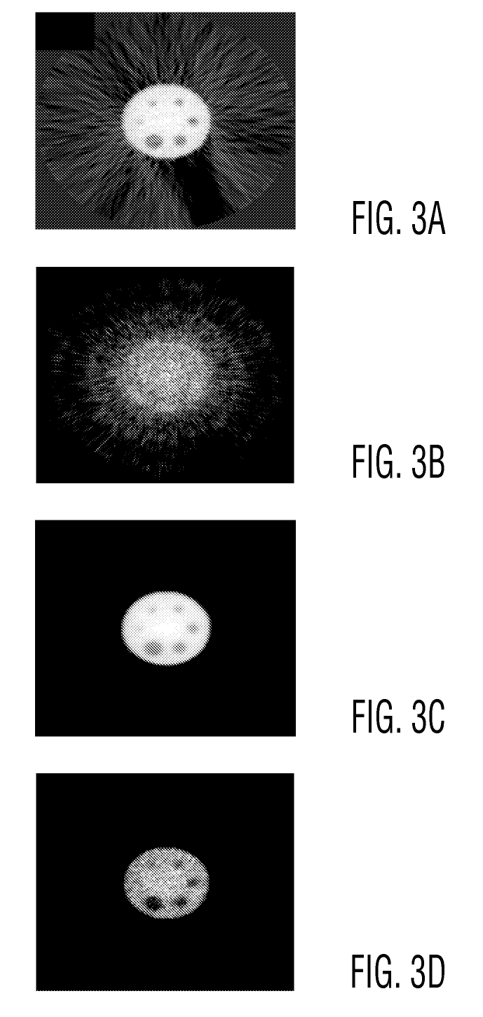

FIG. 3 illustrates phantom dataset reconstruction and statistical analysis;

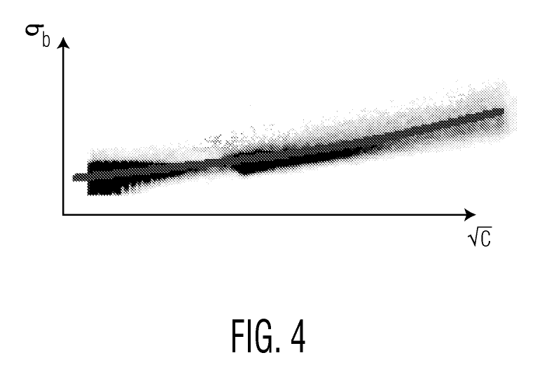

FIG. 4 illustrates standard deviation plotted against square root of the count rate; and

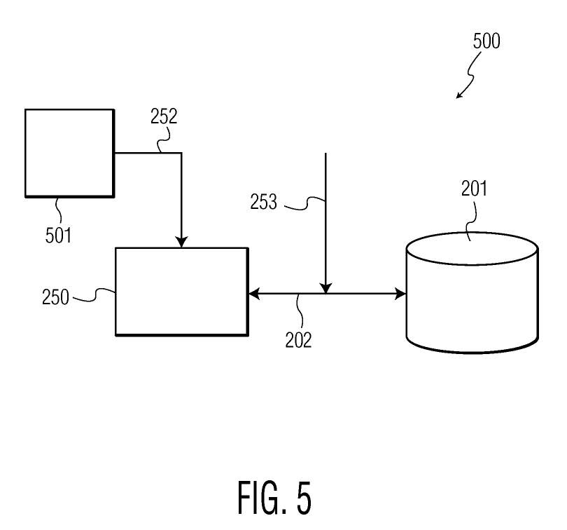

FIG. 5 illustrates an imaging system incorporating the image analysis apparatus of FIG. 2B.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

A preferred embodiment of the invention is as follows:
1. Variance images are generated for a set of pre-determined clinically relevant imaging situations/set-ups. For example, these variance images can be generated using the bootstrap method or by use of repeated measurements. Another technique that can be used is Monte-Carlo simulation.
2. The noise characteristic for each set-up is parameterized as described below and the parameters are stored in a database together with the parameters that define the specific imaging situation, for example “brain imaging, CT-based attenuation correction, non-uniform scatter correction, OSEM reconstruction with 2 iterations and 8 subsets, and 2×2×4 mm³ voxel size”.
3. This database is provided by a vendor of an acquisition system but it can also be updated to include new parameter sets generated by a user.
4. The user acquires and handles the data as usual at step 101. An appropriate noise model is chosen from the database 201 (manually or automatically) depending on the settings of the imaging pipeline (see example in step 2, above). This model is then used for the further analysis of the reconstructed image 102, e.g., kinetic modeling, SUV quantification with confidence levels, etc., at step 203

The following example illustrates a preferred embodiment of step 2. Referring now to FIG. 3, illustrated therein are phantom datasets reconstructed with filtered back projection (a) and iterative row action maximum likelihood algorithm 2d (RAMLA2D), see, e.g., J. A. Browne and A. R. De Pierro, A Row-Action Alternative To The EM Algorithm For Maximizing Likelihoods In Emission Tomography, IEEE Transactions on Medical Imaging, Vol. 15, pp. 687-699, 1996, (c), respectively. The corresponding variance images (b) and (d) were generated with the bootstrap method. The bootstrap method was used to generate the variance images shown in FIG. 3, which are based on the same data but were reconstructed with different reconstruction methods.

The bootstrap approach is a computer-based statistical method for determining the accuracy of a statistic θ (e.g., median) estimated from experimental data (see, e.g., Efron and Tibshirani, An Introduction to the Bootstrap, New York: Chapman and Hall, 1993). It requires an experimental sample x=(x₁, . . . , x_{N}) whose empirical distribution estimates an unknown distribution F. In this sample, each measurement xi is considered as an independent random realization of the variable that follows distribution F. Under its simplest form, the bootstrap uses what is called a plug-in principle:
Given the empirical sample x=(x₁, . . . , x_{N}), draw B independent bootstrap samples x=(x₁^{b}*, . . . , x_{N}^{b}*) of N elements xᵢ^{b}* each. Each element xᵢ^{b}* is obtained by randomly drawing with replacement one element xᵢ from the original empirical sample x. Note that the number of elements in each bootstrap sample is identical to the number of elements in the original empirical sample.
for each bootstrap sample x^{b}*, calculate the statistic of interest θ(x^{b}*), which is called a bootstrap replication of θ.

The set of bootstrap replications {θ(x^{b}*)}_{b=1,B} yields the bootstrap distribution of θ, from which the statistical behavior of θ can be inferred. For instance, the bootstrap variance M₂ (moment of order 2) of θ is

$${M}_{2} = {\sum }_{b = 1}^{B} {( θ ( {x}^{{b}^{*}} ) - {M}_{1} )}^{2} / ( B - 1 )$$

where M₁=Σ_{b=1}^{B}θ(x^{b}*)/B is the mean of θ over the B bootstrap replications.

It should be emphasised again, that the large difference in the noise characteristics, which is obvious in the variance images, is not taken into account in today's kinetic modeling tools.

Now, a suitable parameterization of the noise characteristics can be determined by analysing the correlation between the number of counts and its variance for each pixel, as shown in FIG. 4 for the iteratively reconstructed image.

It is known from literature, see, e.g., H. H. Barrett, et al., Noise Properties of the EM Algorithm: I. Theory, Phys. Med. Bio., 39, pp. 833-46, 1994, that iterative methods based on the maximum likelihood expectation maximization approach (e.g., ML-EM) have a noise characteristic that follows σ=kC^{d}, where σ is the standard deviation and C is the number of counts of the selected pixel. The parameters k and d can now be determined for different imaging situations (brain phantom, whole body phantom, high dose, low dose, etc.) and different image processing settings (with/without scatter correction, CT-based attenuation correction, transmission-based attenuation correction, iterative reconstruction with different numbers of iterations, etc.), indexed according to the situation and setup and stored in a database for retrieval by end-users.

It is important to realize that the generation of a large database is a time-consuming procedure. This, however, is done by the vendor of an imaging device and therefore is no disadvantage for an end-user. The clinician/researcher as an end-user can instantly apply appropriate noise models in his imaging applications by selecting them from the database of the present invention, which database is provided by the vendor of the end-user's imaging system.

FIG. 2B illustrates an apparatus that performs image capture and image processing and that has been modified according to the present invention. Data from an imaging device 251 is captured by module 101 which acquires the data, corrects the data and reconstructs the image. In a preferred embodiment, the Image capture module also accesses a vendor-provided noise model database 201 to obtain an appropriate noise model for the current situation and set-up. The noise model database is further configured to include a noise model creation component 254 that creates noise model entries therein with a pre-selected technique that generates variance images for at least one pre-determined clinically relevant imaging situation and set-up, and indexes each generated variance by at least one noise characteristic and at least one parameter of the corresponding imaging situation/set-up.

The appropriate noise model 202 and reconstructed image 252 are then input to an image processing module 203 for processing of the image. In an alternative embodiment, there is no appropriate noise model and the image processing module is supplied a user-defined noise model 253 by an end-user which is then stored in the noise model database 201 by updating the database.

FIG. 5 illustrates an imaging system that includes the imaging device 501 connected to a noise model selection apparatus 250 to provide imaging data 251 to the apparatus that includes a database of noise models 201 supplied by the vendor of the imaging system and which can accept user-defined noise models 253 and update the vendor-supplied noise model database 201 therewith.

While the preferred embodiments of the present invention have been illustrated and described, it will be understood by those skilled in the art that the system and apparatus architectures and methods as described herein are illustrative and various changes and modifications may be made and equivalents may be substituted for elements thereof without departing from the true scope of the present invention. In addition, many modifications may be made to adapt the teachings of the present invention to a particular set-up without departing from its central scope. Therefore, it is intended that the present invention not be limited to the particular embodiments disclosed as the best mode contemplated for carrying out the present invention, but that the present invention include all embodiments falling with the scope of the appended claims.

1. A method for selecting a noise model for an emission tomography imaging pipeline, comprising the steps of:
providing a database of at least one pre-determined noise model for emission tomography, indexed by at least one noise characteristic and at least one parameter of a corresponding imaging situation/set-up as search terms;
characterizing the imaging pipeline by at least one noise characteristic and at least one parameter;
comparing the search terms of the provided database with the at least one noise characteristic and at least one parameter of the imaging pipeline for a match; and
when there is a match, selecting the pre-determined noise model of the corresponding imaging situation/set-up as the noise model for the imaging pipeline.

2. The method of claim 1, further comprising the step of adding a user-defined noise model to the noise model database.

3. The method of claim 1, wherein the providing step further comprises the steps of:
using a pre-selected technique, generating variance images for at least one pre-determined clinically relevant imaging situation and set-up; and
based on the set-up, associating at least one noise characteristic with each generated variance image; and
associating at least one parameter of the imaging situation and set-up with each generated variance image.

4. The method of claim 3, wherein the associating step further comprises the step of determining the at least one noise characteristic by analysis of the correlation between a count rate and a variance of the variance image for selected pixels thereof.

5. The method of claim 4, wherein:
the at least one parameter of the imaging situation is selected from the group consisting of brain phantom, whole body phantom, high dose, and low dose; and
the at least one parameter of the set-up is selected from the group consisting of with scatter correction, without scatter correction, CT-based attenuation correction, transmission-based attenuation correction, iterative reconstruction with a given number X of iterations, and a given voxel size of Y.

6. The method of claim 5, wherein the generating step further comprises the step of prior to generating a variance image, selecting a technique for variance image generation from the group consisting of bootstrap method, repeated measurements and Monte Carlo simulation.

7. The method of claim 6, wherein the at least one parameter is of a type selected from the group consisting of acquisition, data correction and reconstruction.

8. The method of claim 6, wherein the associating step further comprises the step of determining the at least one noise characteristic by analysis of the correlation between a count rate and a variance of the variance image for selected pixels thereof.

9. An apparatus for selection of a noise model for an emission tomography imaging pipeline, comprising:
a noise model database including at least one pre-determined noise model indexed by at least one noise model characteristic and at least one parameter of a corresponding imaging situation/set-up
an image capture module that captures image data and selects an appropriate noise model from the database and outputs the reconstructed image data and the selected noise model;
an image processing module that receives the output reconstructed image data and the selected noise model and applies the selected noise model to the reconstructed image data to estimate noise therein and utilize this information in a further analyses.

10. The apparatus of claim 9, wherein the noise model database is further configured to include a noise model creation component that creates noise model entries therein with a pre-selected technique that generates variance images for at least one pre-determined clinically relevant imaging situation and set-up, and indexes each generated variance by at least one noise characteristic and at least one parameter of the corresponding imaging situation/set-up.

11. The apparatus of claim 10, wherein the noise model creation component is further configured such that the at least one noise characteristic is obtained by an analysis of the correlation between a count rate and a variance of the variance image for selected pixels thereof.

12. The apparatus of claim 11, wherein:
the at least one parameter of the imaging situation is selected from the group consisting of brain phantom, whole body phantom, high does, and low dose; and
the at least one parameter of the set-up is selected from the group consisting of with scatter correction, without scatter correction, CT-based attenuation correction, transmission-based attenuation correction, iterative reconstruction with a given number X of iterations, and a given voxel size of Y.

13. The apparatus of claim 12, wherein the pre-selected technique that generates variance images is selected from the group consisting of bootstrap method, repeated measurements, and Monte Carlo simulation.

14. The apparatus of claim 12, wherein the at least one parameter is of a type selected from the group consisting of acquisition, data correction and reconstruction.

15. A system that selects a noise model for an emission tomography imaging pipeline, comprising:
an imaging device for collection of emission tomography imaging data;
a noise model database that stores at least one noise model of a pre-defined imaging situation/set-up that is indexed therein by an index comprising at least one noise characteristic and at least one pipeline parameter that correspond to the at least one noise model;
a noise model image selection processor subsystem that characterizes the emission tomography imaging pipeline by at least one noise characteristic and at least one parameter and selects an appropriate noise model from the noise model database such that the at least one noise characteristic and at least one parameter of the emission tomography imaging pipeline matches the index of the selected at least one noise model stored in the database.

16. The system of claim 15, wherein the noise model database is further configured to accept at least one update comprising a user-defined noise model.
